(19) United States
(12) Patent Application Publication
(10) Pub. No.: US 2025/0130959 A1
(43) Pub. Date: Apr. 24, 2025

(54) USB TRANSMISSION SYSTEM, DEVICE, PROGRAM AND METHOD

(71) Applicant: NIPPON TELEGRAPH AND TELEPHONE CORPORATION, Tokyo (JP)

(72) Inventors: Tatsuya FUKUI, Musashino-shi, Tokyo (JP); Toshihito FUJIWARA, Musashino-shi, Tokyo (JP); Ryota SHIINA, Musashino-shi, Tokyo (JP); Hiroya ONO, Musashino-shi, Tokyo (JP)

(73) Assignee: NIPPON TELEGRAPH AND TELEPHONE CORPORATION, Tokyo (JP)

(21) Appl. No.: 18/686,842

(22) PCT Filed: Sep. 3, 2021
(86) PCT No.: PCT/JP2021/032413

§ 371 Date: Feb. 26, 2024

(51) Int. Cl. G06F 13/12

(52) U.S. Cl. CPC G06F 13/12; G06F 2213/0042

(57) ABSTRACT

An object of the present disclosure is to enable connection of USB communication between remote locations without need of installation of a computer near a USB device or installation of new software on the server side.

A USB transmission system and a USB transmission method of the present disclosure are a USB transmission system including: a host simulation device that is connected to a USB device via a USB cable; and a device simulation device that is connected to a USB host via a USB cable, the host simulation device and the device simulation device being connected through a communication network, and a USB transmission method executed by the USB transmission system. The host simulation device performs a connection sequence defined by USB with a USB device when the USB device is connected, the host simulation device transmits device information acquired by the connection sequence to the device simulation device, and the device simulation device simulates the USB device on the basis of the device information acquired from the host simulation device, performs the connection sequence with a USB host, and is connected to the USB host.

### TECHNICAL FIELD

The present disclosure relates to a system, a device, a program, and a method for transmitting USB communication to a remote location.

### BACKGROUND ART

With the spread of 5G and Internet of Things (IoT), data centric computing has been advanced in which various Universal Serial Bus (USB) devices such as a USB sensor and a USB camera are widely installed at remote locations, and data generated from the USB devices is collected in a server and analyzed. In order to proceed with this operation, it is necessary to construct a system that collects information of USB devices at remote locations.

In general, in order to implement this system, a system is implemented in which a computer is installed near a USB camera, USB communication is once terminated by the computer, and software for transmitting and receiving data is operated between a server and the computer, whereby data is collected. However, in a case where this method is adopted, there are the following problems.
First problem: A computer needs to be managed because the computer needs to be installed near a USB device.
Second problem: Cooperation is required between data reception software installed on the server side and an analysis application.

Therefore, it is desirable to adopt a mode in which only a transmission device that performs remote transmission is provided between the USB device and the server, and direct USB connection is performed.

A technology for transmitting a USB physical signal on an optical signal is proposed (see, for example, Non Patent Literature 2). In this technology, a USB physical signal is transmitted as it is, and thus it is possible to create a state as if a USB device at a remote location were directly connected to a server. In addition, software processing does not intervene, and thus it is possible to perform high-speed USB data communication without reducing the speed.

In addition, a technology called USB/IP (Internet Protocol), which enables a server to use a USB device connected to a computer at a remote location, is disclosed. (See, for example, Non Patent Literature 1). According to Non Patent Literature 1, USB/IP is a technology in which USB communication is terminated in USB/IP client software, data (USB Request Block) is extracted and transmitted to a remote USB/IP host, and a USB device is simulated by use of the data transmitted to the USB/IP host. Using this technology makes it possible to create a state as if a USB device at a remote location were directly connected to a server.

After USB 3.0, there is a timer called Pending_HP_Timer in the link layer, but the value of the timer is a very small value of about 10 μs although the value varies depending on the device. In this method of extending the physical layer of USB, data can be transmitted only within a distance of about 1 km in view of speed of light.

Although USB communication can be connected between remote locations, it is necessary to operate USB/IP software on both a computer and a server, and thus the problems that it is necessary to manage a computer installed near a USB device and that cooperation is required between data reception software installed on the server side and an analysis application, which have been described in Background Art, cannot be solved.

### CITATION LIST

### Non Patent Literature

Non Patent Literature 1: USB 3.0 extender Spectra 3022, http://bayt.co.jp/products/branded/usb_extender/usb3/spectr a3022.html
Non Patent Literature 2: Takahiro Hirofuchi, Eiji Kawai, Kazutoshi Fujikawa, and Hideki Sunahara, “USB/IP—a Peripheral Bus Extension for Device Sharing over IP Network”, FREENIX Track: 2005 USENIX Annual Technical Conference.https://www.usenix.org/legacy/events/usenix05/the ch/freenix/hirofuchi/hirofuchi.pdf

### SUMMARY OF INVENTION

### Technical Problem

Therefore, an object of the present disclosure is to enable connection of USB communication between remote locations without need of installation of a computer near a USB device or installation of new software on the server side.

### Solution to Problem

A USB transmission system of the present disclosure is
a USB transmission system including:
a host simulation device that is connected to a USB device via a USB cable; and
a device simulation device that is connected to a USB host via a USB cable,
the host simulation device and the device simulation device being connected through a communication network, wherein
the host simulation device performs a connection sequence defined by USB with a USB device when the USB device is connected,
the host simulation device transmits device information acquired by the connection sequence to the device simulation device, and
the device simulation device simulates the USB device on the basis of the device information acquired from the host simulation device, performs the connection sequence with a USB host, and is connected to the USB host.

A USB transmission method of the present disclosure is a USB transmission method executed by the USB transmission system.

In addition, a USB transmission device of the present disclosure functions as the host simulation device or the device simulation device included in the USB transmission system.

### Advantageous Effects of Invention

According to the present disclosure, it is possible to enable connection of USB communication between remote locations without need of installation of a computer near a USB device or installation of new software on the server side.

### BRIEF DESCRIPTION OF DRAWINGS

FIG. 1 illustrates an outline of a system configuration of the present disclosure.

FIG. 2 illustrates an outline of a layer configuration of the system of the present disclosure.

FIG. 3 illustrates an outline of a system configuration of the present embodiment.

FIG. 4 illustrates an example of the system configuration of the present embodiment.

FIG. 5 illustrates an example of a connection destination device simulation device recording table.

FIG. 6 illustrates an example of an initial connection flow.

FIG. 7 illustrates an example of an IN communication flow.

FIG. 8 illustrates an example of an OUT communication flow.

### DESCRIPTION OF EMBODIMENTS

Hereinafter, an embodiment of the present disclosure will be described in detail with reference to the drawings. Note that the present disclosure is not limited to the embodiment described below. These embodiments are merely examples, and the present disclosure can be carried out in a form with various modifications and improvements based on the knowledge of those skilled in the art. Note that components having the same reference signs in the present specification and the drawings indicate the same components.

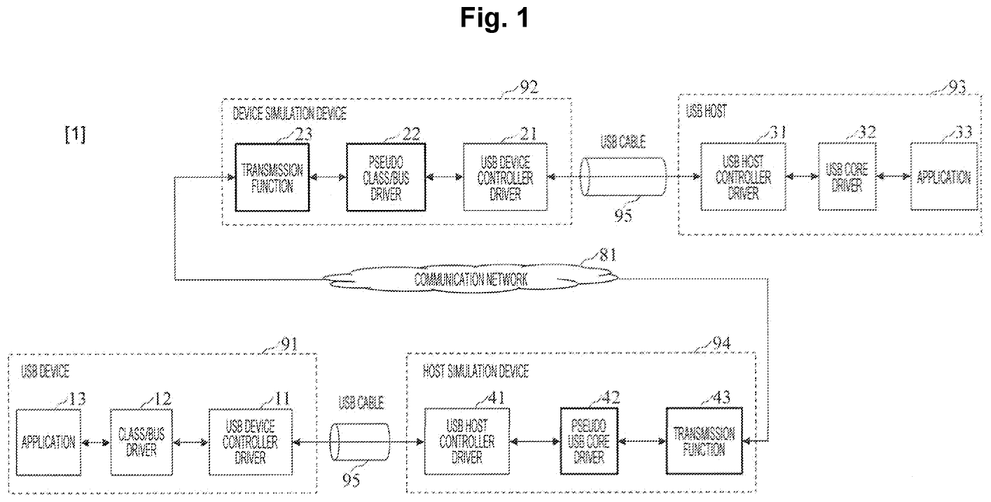

FIG. 1 illustrates an outline of a system configuration of the present disclosure. The system of the present disclosure is a USB transmission system including a USB device 91 and a USB host 93, and further includes a device simulation device 92 that simulates the operation of the USB device 91 and a host simulation device 94 that simulates the operation of the USB host 93. The device simulation device 92 and the host simulation device 94 function as USB transmission devices of the present disclosure.

Each of the USB transmission devices of the present disclosure can also be implemented by a computer and a program, and the program can be recorded in a recording medium or provided through a network. The program of the present disclosure is a program for causing a computer to be implemented as each functional unit included in the USB transmission devices according to the present disclosure, and is a program for causing a computer to execute each step included in methods executed by the USB transmission devices according to the present disclosure.

The USB device 91 is any device connectable to a computer by USB, and is, for example, a USB camera or a USB sensor. The USB device 91 includes a USB device controller driver 11 and a class/bus driver 12 for transmitting and receiving data to and from the USB host 93, and an application 13.

The USB host 93 is a device that collects data generated from the USB device 91, and is, for example, a server. The USB host 93 includes a USB host controller driver 31 and a USB core driver 32 for transmitting and receiving data to and from the USB device 91, and an application 33.

When the USB device 91 is connected to the USB host 93, the USB host 93 and the USB device 91 perform a connection sequence defined by USB. As a result, the USB host 93 can perform USB communication with the USB device 91 without using a communication network 81. Here, the connection sequence is a series of data exchange from connection of the USB device to recognition by an OS (Windows or the like), and is, for example, an enumeration sequence.

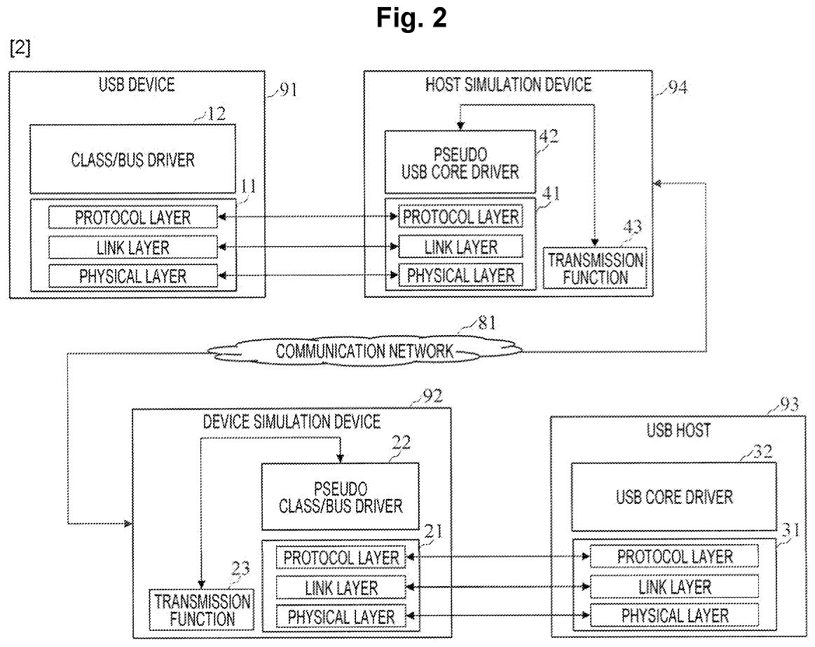

The USB device controller driver 11 and the USB host controller driver 31 perform processing in the physical layer, the link layer, and the protocol layer, as illustrated in FIG. 2, in transmission and reception of data, such as an enumeration sequence. The class/bus driver 12 and the USB core driver 32 perform processing in an upper layer of the protocol layer, as illustrated in FIG. 2, in transmission and reception of data, such as an enumeration sequence.

The host simulation device 94 includes a USB host controller driver 41 having a function equivalent to that of the USB host controller driver 31 and a pseudo USB core driver 42 having a function equivalent to that of the USB core driver 32. With this configuration, the host simulation device 94 can perform USB communication with the USB device 91 instead of the USB host 93.

The device simulation device 92 includes a USB device controller driver 21 having a function equivalent to that of the USB device controller driver 11 and a pseudo class/bus driver 22 having a function equivalent to that of the class/bus driver 12. With this configuration, the device simulation device 92 acquires device information of the USB device 91, and thus can perform USB communication with the USB host 93 instead of the USB device 91.

The device simulation device 92 includes a transmission function 23 for performing communication with the host simulation device 94. The host simulation device 94 includes a transmission function 43 for performing communication with the device simulation device 92.

The system of the present disclosure performs the following connection sequence.

When the USB device 91 is connected, the host simulation device 94 performs an enumeration sequence with the USB device 91 and is connected to the USB device 91. As a result, the host simulation device 94 acquires device information for simulating the device from the USB device 91.

Here, the following information can be exemplified as device information for simulating the device.
Device descriptor
Binary Device Object Store (BOS) descriptor
Configuration descriptor

The host simulation device 94 transmits the device information acquired when connected to the USB device 91 to the device simulation device 92 using the transmission function 43.

The device simulation device 92 receives the device information from the host simulation device 94 using the transmission function 23. The device simulation device 92 simulates the USB device 91 on the basis of the acquired device information, performs an enumeration sequence with the USB host 93, and is connected to the USB host 93.

In the case of IN communication for transmitting data from the USB device 91 to the USB host 93, the system of the present embodiment transmits the data as follows.
The host simulation device 94 transmits data obtained as a result of USB communication with the USB device 91 to one or more device simulation devices 92.
The device simulation device 92 transmits the received data to the USB host 93 through USB communication with the USB host 93. At this time, the USB communication is performed by use of device information received from the host simulation device 94.

Here, the host simulation device 94 may transmit the device information to a plurality of device simulation devices 92. In this case, the device simulation devices 92 that have received the device information each behave as the same USB device 91, and can transmit the data from one USB device 91 to different USB hosts 93.

In the case of OUT communication for transmitting data from the USB host 93 to the USB device 91, the system of the present embodiment transmits the data as follows.
The device simulation device 92 transmits data obtained as a result of USB communication with the USB host 93 to one host simulation device 94.
The host simulation device 94 transmits the received data to the USB device 91 through USB communication with the USB device 91.

According to the present disclosure, remote connection with the USB device 91 is possible without the USB host 93 being handled. Furthermore, according to the present disclosure, data obtained from one USB device 91 can be transmitted to a plurality of USB hosts 93.

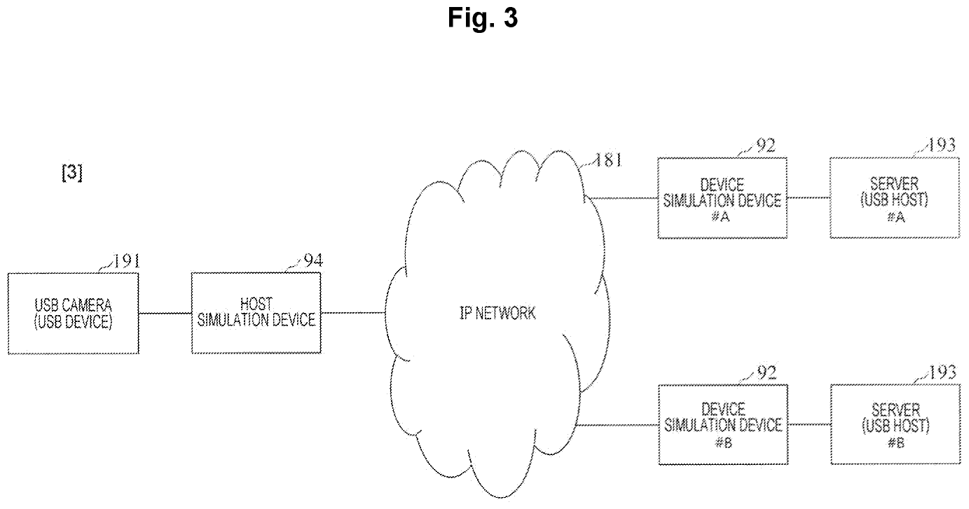

FIG. 3 illustrates an example of the system configuration of the present embodiment. In the present embodiment, for easy understanding, an example is shown in which the USB hosts 93 are two servers 193 and the USB device 91 is one USB camera 191. Note that each of the number of USB devices 91 and the number of USB hosts 93 may be any number of one or more. Each of the servers 193 is provided with one device simulation device 92. In the present embodiment, in a case where there are two servers 193, device simulation devices 92#A and 92#B are provided. In addition, an example in which the communication network 81 is an IP network 181 is shown.

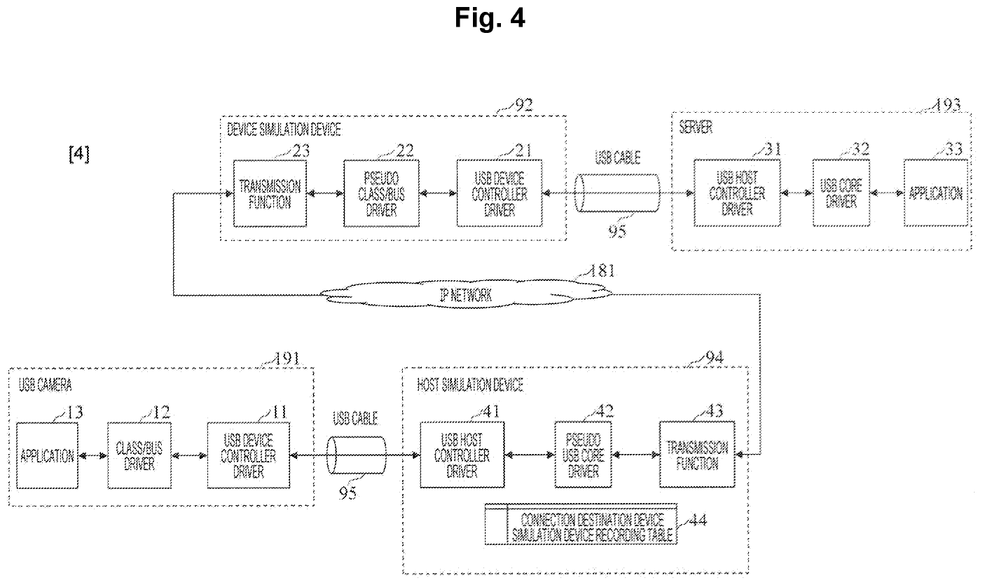

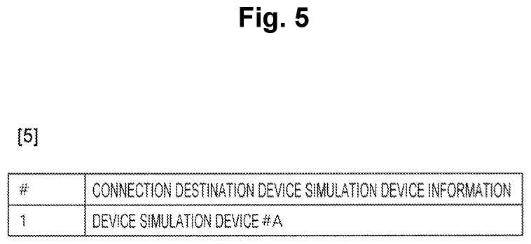

FIG. 4 illustrates an example of the system configuration of the present embodiment. The host simulation device 94 includes a connection destination device simulation device recording table 44. The connection destination device simulation device recording table 44 describes the device simulation device 92 to which the host simulation device 94 is connected. FIG. 5 illustrates an example of the connection destination device simulation device recording table.

For example, in a case where the USB camera 191 is connected to a server 193#A, the device simulation device #A is described as connection destination device simulation device information in the connection destination device simulation device recording table included in the host simulation device 94 connected to the USB camera 191. Note that there may be a plurality of devices described in the connection destination device simulation device information.

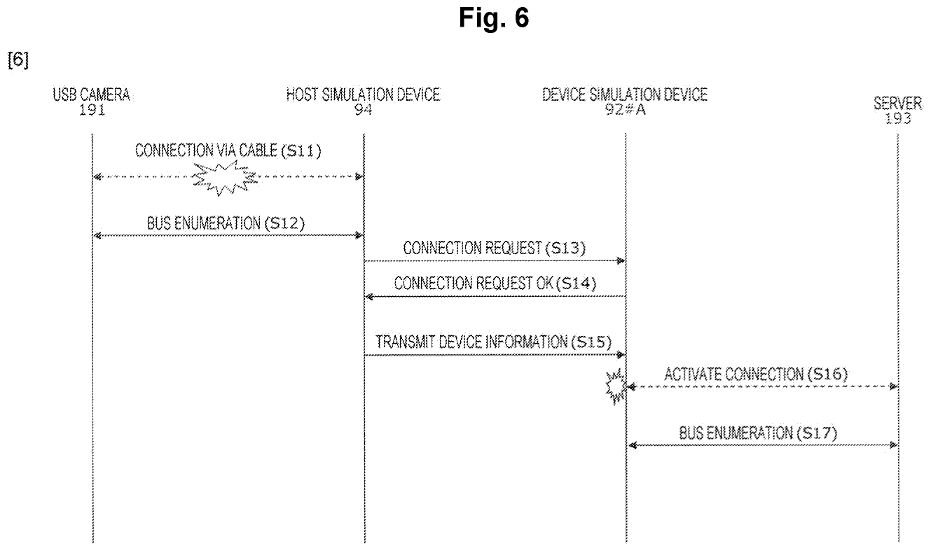

FIG. 6 illustrates an example of an initial connection flow.

The USB camera 191 and the host simulation device 94 are connected via a cable 95 (S11). The USB camera 191 and the host simulation device 94 then execute bus enumeration (S12). Here, the bus enumeration is a predetermined procedure when the USB device is connected, and it is possible to use the same procedure as that of a normal operation when the USB device 91 and the USB host 93 are connected.

When the bus enumeration (S12) is completed, the host simulation device 94 makes a connection request to the device simulation device 92 (S13). At this time, the host simulation device 94 makes a connection request to the device simulation device 92 described in the connection destination device simulation device recording table 44. In the present embodiment, since the device simulation device #A is described as connection destination device simulation device information, the host simulation device 94 makes a connection request to the device simulation device 92#A.

When receiving the connection request from the host simulation device 94, the device simulation device 92#A returns a connection request OK. Here, the device simulation device 92#A determines whether the device simulation device 92#A is connected to a host simulation device 94 other than the host simulation device 94 as a transmission source of the connection request, and returns a connection request OK in a case where the device simulation device 92#A is not connected to another host simulation device (S14). When receiving the connection request OK, the host simulation device 94 transmits device information to the device simulation device 92#A (S15).

When receiving the device information, the device simulation device 92#A activates connection with the server 193 via the USB cable 95 (S16). The device simulation device 92#A and the server 193 then execute bus enumeration (S17). At this time, the device simulation device 92#A behaves as the USB camera 191 using the received device information to perform connection with the server 193.

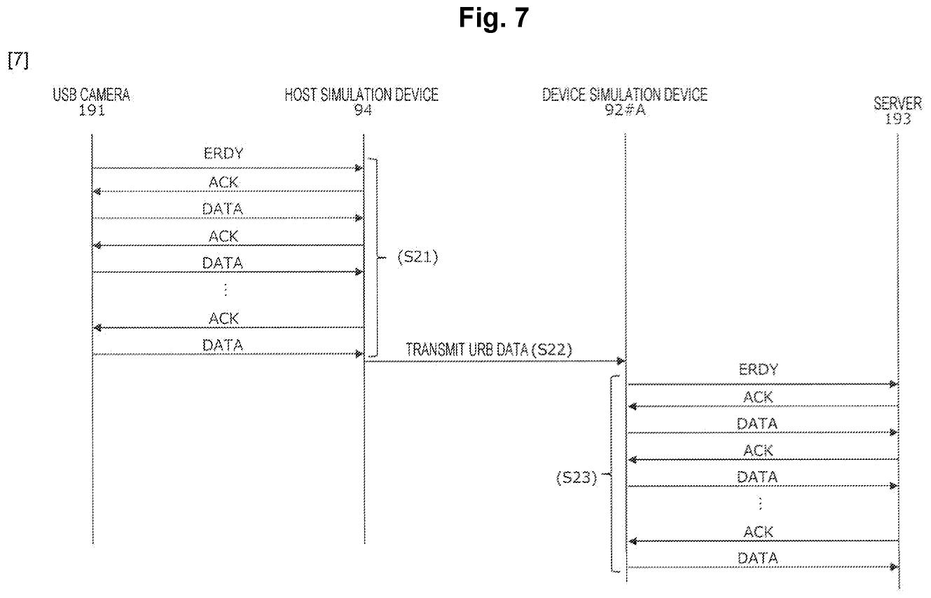

FIG. 7 illustrates an example of an IN communication flow.

The host simulation device 94 sends an ACK to the USB camera 191 to start transmission of data (S21).

The transmission function 43 of the host simulation device 94 transmits URB data obtained from the pseudo USB core driver 42 to the device simulation device 92#A (S22).

The device simulation device 92#A transmits the data to the server 193 using the received URB data (S23). At this time, in the device simulation device 92#A, the transmission function 23 passes the received URB data to the pseudo class/bus driver 22, and the pseudo class/bus driver 22 transmits the data using the URB data.

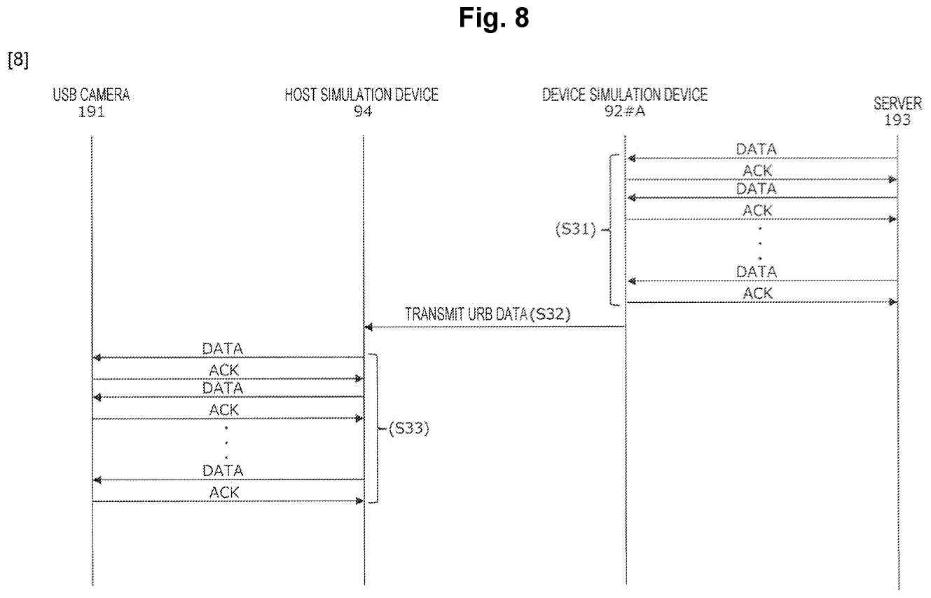

FIG. 8 illustrates an example of an OUT communication flow.

The server 193 transmits data to the device simulation device 92#A (S31).

The device simulation device 92#A transmits the data received from the server 193 to the host simulation device 94 (S32). At this time, the transmission function 23 of the device simulation device 92#A transmits URB data obtained from the pseudo class/bus driver 22 to the host simulation device 94.

The host simulation device 94 transmits the data received from the device simulation device 92#A to the USB camera 191 (S33). At this time, the transmission function 43 of the host simulation device 94 passes the URB data received from the device simulation device 92#A to the pseudo USB core driver 42, and the pseudo USB core driver 42 transmits the data to the USB camera 191 using the URB data.

Transmission methods by the transmission functions 23 and 43 are any methods. For example, a connection may be established and data may be transmitted by use of an IP packet. Here, the connection may be established by any method, and for example, the Transmission Control Protocol (TCP) is used to establish a TCP connection, the Security Architecture for Internet Protocol (IPsec) is used to establish an IPsec connection, and UDP is used to establish a UDP socket and exchange a test packet.

### INDUSTRIAL APPLICABILITY

The present disclosure can be applied to the information and communication industry.

### REFERENCE SIGNS LIST

11 USB device controller driver
12 Class/bus driver
13 Application
21 USB device controller driver
22 Pseudo class/bus driver
23, 43 Transmission function
31 USB host controller driver
32 USB core driver
33 Application
41 USB host controller driver
42 Pseudo USB core driver
44 Connection destination device simulation device recording table
91 USB device
92 Device simulation device
93 USB host
95 USB cable
94 Host simulation device
191 USB camera
193 Server

1. A USB transmission system comprising:
a host simulation device that is connected to a USB device via a USB cable; and
a device simulation device that is connected to a USB host via a USB cable,
the host simulation device and the device simulation device being connected through a communication network, wherein
the host simulation device performs a connection sequence defined by USB with a USB device when the USB device is connected,
the host simulation device transmits device information acquired by the connection sequence to the device simulation device, and
the device simulation device simulates the USB device on a basis of the device information acquired from the host simulation device, performs the connection sequence with a USB host, and is connected to the USB host.

2. The USB transmission system according to claim 1, wherein
the host simulation device transmits data obtained as a result of USB communication with a USB device to one or more device simulation devices, and
the one or more device simulation devices transmit the data received from the host simulation device to one or more USB hosts through USB communication based on the device information.

3. The USB transmission system according to claim 1, wherein
the device simulation device transmits data obtained as a result of USB communication with a USB host to one host simulation device, and
the one host simulation device transmits the data received from the device simulation device to a USB device through USB communication based on the device information.

4. A USB transmission device configured to function as a host simulation device that is connected to a USB device via a USB cable, wherein USB transmission device
is connected through a communication network to a device simulation device that is connected to a USB host via a USB cable,
performs a connection sequence defined by USB with a USB device when the USB device is connected, and
transmits device information acquired by the connection sequence to one or more device simulation devices.

5. A USB transmission device configured to function as a device simulation device that is connected to a USB host via a USB cable, wherein the USB transmission device
is connected through a communication network to a host simulation device that is connected to a USB device via a USB cable,
receives, from the host simulation device, device information acquired by the host simulation device performing a connection sequence defined by USB with a USB device, and
simulates the USB device on a basis of the device information acquired from the host simulation device, performs the connection sequence with a USB host, and is connected to the USB host.

6. A program for causing a computer to be implemented as each functional unit included in the USB transmission device according to claim 4.

7. (canceled)
